(19) United States
(12) Patent Application Publication
(10) Pub. No.: US 2013/0286781 A1
(43) Pub. Date: Oct. 31, 2013

(54) Method and Apparatus for Selective Seismic Detection of Elongated Targets

(71) Applicant: Thomas E. Owen, Helotes, TX (US)

(72) Inventor: Thomas E. Owen, Helotes, TX (US)

(21) Appl. No.: 13/867,260

(22) Filed: Apr. 22, 2013

Related U.S. Application Data
(60) Provisional application No. 61/640,088, filed on Apr. 30, 2012.

(51) Int. Cl. G01V 1/28

(52) U.S. Cl. CPC G01V 1/284
USPC 367/47

(57) ABSTRACT

A seismic wave source and sensing system coupled to the surface of an elastic wave propagation medium has a seismic wave source transducer having a preferred axis of vibration oriented horizontally on the surface of the elastic wave propagation medium. A seismic wave sensing transducer has a preferred axis of vibration response oriented horizontally on the surface of said elastic wave propagation medium such that said sensing transducer is capable of detecting dynamic particle motions and displacements of SH waves. An arrangement of the source and sensing transducers is provided on the surface of the elastic wave propagation medium. A recording system capable of acquiring and storing reflected SH wave signals detected by the sensing transducer, wherein the recorded signals represent reflections from contrasting physical properties within the elastic wave propagation medium to provide preferential detection of elongate subsurface targets such as utility pipes, conduits, and other similar object.

This application claims priority to U.S. Provisional Patent Application Ser. No. 61/640,088 filed 30 Apr. 2012, which is incorporated herein by reference for all purposes.

### BACKGROUND OF INVENTION

Conventional seismic reflection techniques employing one or more line of detectors and using a compressional (P) wave source located at positions distributed along the detector line are not particularly effective in detecting slender one-dimensional targets such as underground pipes in shallow unconsolidated soil media. The primary limitations are related to: (1) the important need for short wavelength target illumination comparable with the diameter of pipe targets of interest to obtain useful reflection signals; (2) the difficulty of generating high-frequency (short wavelength) seismic source signals using conventional P-wave sources; (3) the detrimental effect of anelastic absorption of such short wavelengths in soil materials; (4) off-vertical refraction effects caused by positive velocity gradients with depth in shallow unconsolidated soils; (5) the reflection coefficient of cylindrically shaped targets such as a pipe which contains an inherent partition of reflected energy in the form of P wave conversion to shear (S) waves when the incident wave is generated by a compressional wave source; and (6) the need for off-line data processing.

Better suited for such pipe detection purposes is the use of a closely spaced source and sensor transducer system to produce localized near-vertical short-path illumination and to receive relatively short-path near-vertical reflections from the subsurface target. By constraining the two-way seismic propagation path to such near-vertical illumination and reflection, the use of short wavelengths will be more practical since distance-dependent attenuation and refraction effects inherent in the host soil medium will be minimized. Moreover, the surface position of the source-sensor transducer pair at the point of detection will provide a direct indication of the underground pipe location. Furthermore, since S waves propagate at much lower velocities than P waves in shallow unconsolidated soils, S waves offer the advantage of having much shorter wavelengths at frequencies capable of being generated by practical seismic sources. In addition to these advantages, reflections of horizontally polarized shear (SH) waves from elongate cylindrical targets have distinctively different characteristics for SH-wave polarization incident parallel to the cylinder axis compared with SH-wave polarization incident perpendicular to the axis. In particular, incident SH waves polarized parallel to the pipe axis will yield the strongest shear wave reflections whereas perpendicular SH-wave polarization will result in only very weak shear wave reflections. Furthermore, SH waves incident at oblique angles greater than 45-50 degrees away from parallel incidence will be partially converted into reflected and scattered compressional waves because of the cylindrical curvature and to “creeping” waves that travel around the circumferential surface of the pipe. Thus, an SH-wave source and SH-wave sensor system operating in a near-vertical seismic reflection arrangement represents a more versatile approach to surveying for and detecting, interpreting, and mapping shallow elongate targets such as underground utility pipes without the need for off-line processing.

Improvements in small, wide-bandwidth vibrator sources for use in surveys for engineering and geotechnical seismic applications suggest that new advanced field techniques and instrumentation may also be of further benefit in such underground utility pipe detection and mapping applications. In particular, the electrodynamic vibrator sources disclosed in U.S. Pat. No. 6,119,804 for SH waves and in U.S. Pat. No. 6,488,117 for P waves have been effective in generating high-resolution controlled waveform seismic waves at frequencies up to 2,000 Hz, and higher. The SH-wave source generates horizontally polarized shear waves that ere essentially free of concurrent P waves in the propagation direction orthogonal to the shear displacement motion of the transducer. While these sources have solved the important need for generating high-resolution source signals for detecting underground pipes, the basic methods relevant to pipe detection are limited by two critical factors: (1) attenuation of high-frequency seismic signals in unconsolidated soils; and (2) masking of weak reflections from underground targets by seismic wave energy transmitted directly from the surface-based source to the nearby surface-based sensor. The first factor, inherent in soil materials in which underground pipes are installed, is caused by viscoelastic frequency-dependent absorption of seismic wave vibrations. In particular, the preferred higher frequency vibrations are absorbed more strongly than vibrations at lower frequencies. Therefore, attenuation tends to reduce the strength of the desired short wavelength reflections from pipe targets more severely than the undesired lower frequency reflections from larger anomalies in the vicinity of the pipe. As a consequence, seismic reflections from pipe targets are usually weak and may be near the threshold of detection using state-of-the-art instrumentation.

The second factor above is a self-interference effect inherent in most seismic exploration systems and, in conventional practice, cannot be completely avoided. This interference is caused by the close proximity of the source and sensor transducers and direct transmission of the locally strong source signals over the short path between the source and sensor. Such strong direct-arriving signals can mask the weak pipe reflections of interest and can overdrive the receiving system, preventing its operation at the desired high-sensitivity needed to reveal otherwise threshold detectable signals. However, the fact that seismic shear wave transducers can be oriented to have an inherent null response in their polarized shear wave radiation and receiving operation offers a potentially useful feature by which the direct cross-feed interference and dynamic range limitations may be reduced or eliminated.

Horizontally polarized shear waves generated at the surface and radiated into the ground have particle motions perpendicular to the direction of propagation and parallel to the ground surface. More specifically, the SH-wave source has its motional axis parallel to the ground surface causing dynamic shear stress vibrations to radiate in the direction perpendicular to the source motional axis. Thus, when the source can be considered as a small point source, SH waves radiate and illuminate a semi-circular vertical cross-section of the subsurface with its center located at the motional axis of the vibrator source. No SH waves are generated or radiated in the direction of the vibrator motional axis. In analytical form, the point-source pattern has the shape of one-half of a torroid centered on the transducer horizontal motional axis. By reciprocity, the receiving pattern or spatial field of view of a point SH-wave sensor is identical to that of a point SH-wave source.

With regard to reflections from subsurface targets, when an SH wave propagates downward through a horizontally stratified soil medium consisting of soil layers having contrasting material properties, reflections will occur at each layer as pure SH waves having particle motions parallel to the layering and unchanged from the incident SH-wave polarization without energy partition into P waves. On the other hand, if the ground medium is homogeneous and a horizontal cylinder target made of a material having contrasting physical properties relative to those of the surrounding ground is present, SH waves will be strongest when the illuminating wave particle motion, i.e., the incident SH-wave polarization, is parallel to the cylinder axis. In this case, the SH-wave reflection will be polarized parallel to the cylinder axis without energy partition into P waves. When the SH wave particle motions are perpendicular to the cylinder axis, the dynamic shear stresses incident on the curved surface are diffused and scattered as weak SH-wave reflections polarized perpendicular to the cylinder axis and relatively strong energy-partitioned P-wave reflections.

In the more general case, where the incident SH wave polarization is oriented at an oblique angle to the cylinder axis, the incident wave can be considered to consist of two components, one component polarized parallel to the cylinder axis and one component polarized perpendicular to the cylinder axis. Thus, the parallel component will result in a pure SH-wave reflection whereas the perpendicular component will be partitioned into diffused P-wave and SH-wave reflections. As one example, if the SH-wave polarization is at about 45 degrees with respect to the cylinder target axis, approximately one half of the incident energy will be reflected as an SH wave having its polarization parallel to the target axis and the other half diffused and scattered as P waves and weaker SH waves polarized perpendicular to the target axis. Therefore, the reflection coefficient of SH waves incident on elongate cylindrical targets is recognized as being selectively characteristic of such targets and also dependent upon the angle of incidence of the illuminating SH waves. The converted P-wave reflections generated by oblique incidence SH waves are directly associated with the pipe target and form a distinct feature of the pipe reflection signature. By adding appropriate P-wave sensors as part of the surface sensor transducer, this supplemental P-wave feature of the pipe reflection can also be detected.

The descriptions presented above characterize the interactions between close-spaced SH-wave source and sensor transducers and the selective nature of SH-wave reflections from cylindrical target objects such as underground utility pipes. The invention described in detail below offers a unique approach to overcoming the limitations of standard seismic methods described earlier by utilizing features inherent in horizontally polarized shear waves in combination with the selective reflection characteristics of such waves from elongate cylindrical targets.

As described above, when an SH source and an SH sensor are located close together with their sensitive axes oriented parallel, the principal seismic signal detected by the sensor is the direct cross-feed arrival from the source. Conversely, if the sensor is oriented with its sensitive axis perpendicular to the SH polarization of the source, the cross-feed interference from the source will be rejected by the null-response orientation of the sensor. This orthogonal null response to direct interference from the source is an important first step in minimizing cross coupling between the source and sensor transducers and the associated limitation in the dynamic detection range of the receiving system.

As further described above, SH-wave reflections at a subsurface horizontal layer interface retain their pure SH-wave polarization characteristics and, as a consequence, these reflections would also be rejected by the orthogonal null response of the sensor. Therefore, in a seismic reflection system intended to selectively detect one-dimensional cylindrical pipe targets, an orthogonally oriented source and sensor transducer system has a null response to direct cross-feed interference and to reflections from horizontal layer interfaces in the host soil medium.

Next, consider the response of the orthogonally oriented transducer pair to reflections from an elongated cylinder target. In a first case wherein the SH-wave radiation from the source is polarized parallel to the cylinder axis, the reflections will be pure SH waves having the same polarization and, therefore, will be rejected by the orthogonal sensor null response. In a second case, wherein the SH-wave radiation from the source is polarized perpendicular to the cylinder axis, the reflections will consist of diffused and scattered SH and P waves, with the SH polarization perpendicular to the sensitive axis of the sensor and with the P-wave displacement motions in the radial direction around the cylinder. Therefore, in this case, the reflected SH waves will also be rejected by the orthogonal sensor null response. In a third case, wherein the SH-wave radiation from the source is polarized obliquely to the axis of the cylinder, the different magnitudes of the axial and transverse SH reflections from the cylinder will combine to produce a resultant reflection component that will be polarized parallel to the sensitive axis of the sensor. Therefore, by intentionally orienting the orthogonal SH-wave source-sensor transducer pair to have an orthogonally null response to minimize cross-feed interference, oblique SH-wave reflections from elongate cylinder targets can potentially be detected while cross-feed and reflections from horizontal layers are rejected. Therefore, with approximate knowledge of the layout of a subsurface utility pipe target, such as being aligned along the traffic lanes of a street, the source-sensor pair may be oriented at an oblique angle and moved incrementally along or perpendicular to the alignment path to detect and map the subsurface pipe location. The reflected P-waves associated with such oblique-incidence SH waves provide a supplemental detection response associated with the elongate cylindrical targets of interest and may be detected at the surface by including a sensor transducer having vertical-axis (P-wave) sensitivity.

The SH-wave source and sensor transducers have been described above as point source and point-sensor devices having semicircular torroidal radiation and receiving field-of-view patterns in the subsurface soil medium. In practice, these transducers will have finite-area apertures in contact with the ground so that, when operating at sufficiently high frequencies, they will exhibit desirable radiation and receiving beam patterns that confine the combined field of view within a relatively narrow near-vertical downward direction. This directional feature of the transducer system can be emphasized by intentionally increasing the size of the source and sensor transducer apertures. For such finite-aperture transducers, the orthogonal null response orientation condition places additional constraints on the source and sensor devices, including symmetry about the line through their centers and also requires that the soil comprising the cross-feed path be reasonably uniform in propagation velocity and attenuation. With these constraints satisfied, even approximately, the bounded near-vertical field of view will be a significant advantage in offsetting the effects of attenuation in the pipe burial soil medium and rejecting reflections from non-pipe targets.

Thus, the seismic system, having orthogonal SH-wave source and sensor array orientation and bounded near-vertical field of view, is one in which direct SH-wave interference from the source array to the sensor array is rejected and which responds only to subsurface reflecting pipe targets located approximately directly below the source-sensor transducer pair. When the sensor array is adapted to also receive P-wave reflections, the orientation of the SH-wave source required to null the SH-wave cross-feed interference will also result in minimum direct cross-feed P-wave interference to the vertical-axis P-wave sensing transducers mounted in the sensor array. This near-vertical geometry of the pipe target reflections eliminates the need for the extensive data processing requirements associated with conventional seismic reflection data analysis. In further contrast with conventional seismic reflection methods, imaging of subsurface pipe targets is accomplished using this system by systematically scanning the source-sensor transducer pair over the ground surface of interest and displaying the reflection data to indicate the pipe detection position and depth.

### BRIEF SUMMARY OF THE DRAWINGS

The following figures illustrate the general configuration and subsurface field of view of the near-vertical sounding SH-wave transducer arrangement and further illustrate the manner in which an orthogonal SH-wave source-sensor transducer pair is deployed in oblique orientation to selectively detect cylindrical pipe targets while nulling out direct cross-feed interference.

FIG. 1A illustrates the calculated radiation pattern of an idealized SH-wave point source showing the torroidal shape of the subsurface illumination zone and identifying the SH-wave radiation direction and the SH-wave null response axis.

FIG. 1B illustrates the calculated P-wave radiation pattern of the SH-wave source showing the orthogonal direction of P-wave radiation with the P-wave null in the direction of maximum SH-wave radiation.

FIG. 2 shows point Receiver R1 with its SH-wave sensing direction oriented toward a point SH-wave source to obtain maximum response and point Receiver R2 with its SH-wave sensing direction oriented toward the same SH-wave point source to obtain null response.

FIG. 3A shows point Receiver R1 and point Receiver R2 laterally offset in the y-direction to illustrate how the null response of receiver R2 remains nulled independent of the magnitude of the y-axis offset distance.

FIG. 3B shows the direct P-wave interference from a point SH-wave source at a point P-wave receiver laterally offset in the y-direction compared with receivers located at the P-wave source null direction.

FIGS. 4A through 4D show a series of calculated radiation patterns of a finite-aperture SH-wave source transducer indicating the increase in directivity versus frequency.

FIG. 5 shows a multiple-point source array and a multiple-point sensor array in plan view on the ground surface. Examples of sensor response similar to those shown in FIG. 3A are illustrated.

FIG. 6 presents a three-dimensional view of an obliquely oriented orthogonal source-sensor transducer pair over a cylindrical target to illustrate the dynamic displacement motions and polarizations of the incident and reflected SH-wave components.

FIG. 7 shows a plan view of an obliquely oriented orthogonal source-sensor transducer pair along a survey path overlying an elongate subsurface pipe scanned along survey paths either oriented parallel to or perpendicular to an underlying elongate subsurface pipe.

FIG. 8A and FIG. 8B shows two sketches of typical SH-wave seismic reflection cross-sections: one with the orthogonal transducer-pair obliquely oriented and scanned transverse to the pipe axis and one with the orthogonal transducer-pair obliquely oriented and scanned parallel to the pipe axis, respectively.

FIGS. 9A through 9D show plots of SH-wave reflection amplitude versus oblique polarization incidence angle for two different pipe sizes at a common depth below surface.

### DETAILED DESCRIPTION OF A PREFERRED EMBODIMENT OF THE INVENTION

The invention disclosed herein refers to a high-resolution seismic reflection technique utilizing horizontally polarized shear (SH) wave source and sensor transducers to provide operating features and functions for selectively detecting and mapping elongate cylindrical targets such as shallow underground pipes or conduits. The principal features and functions exemplified by this invention are:

(1) A seismic vibrator source capable of generating SH waves in the frequency range 50-2,000 Hz when coupled to ground surfaces such as soil or paved surfaces overlying soil; the soil being the host medium potentially containing one or more underground utility pipes or conduits;

(2) A seismic sensor capable of detecting SH waves when coupled to ground surfaces such as soil or paved surfaces overlying soil; the soil being the host medium potentially containing one or more underground utility pipes or conduits;

(3) The SH-wave source and SH-wave sensor in (1) and (2) arranged in orthogonal orientation relative to one another such that the SH-wave vibrations generated at the source and transmitted directly through the ground to the sensor are incident on the null response axis of the sensor; the line through the centers of the ground contact areas of these orthogonally oriented transducers designated as the transducer-pair axis;

(4) The orthogonal SH-wave transducer pair coupled to the ground surface at incremental positions along a known or assumed alignment of an underground utility pipe or conduit typically having the shape of an elongate cylinder; the transducer pair axis being oriented at an oblique angle relative to the alignment direction of the underground utility pipe or conduit; and

(5) The orthogonal transducer pair in combination with its oblique orientation with respect to the underground cylindrical target being capable of selectively detecting SH-wave reflections from the cylinder while rejecting direct SH-wave source-to-sensor interference and SH-wave reflections from horizontal layers in the soil medium; the reflection response of the elongate cylinder being an important signature feature in the selective target detection process.

(6) The orthogonal transducer pair in which the sensor array component also contains vertical-axis sensing transducers for detecting P waves produced when SH waves from the source are incident on the cylindrical target at an oblique polarization relative to the cylinder axis; the converted P-wave reflections being caused by the curvature of the cylinder and representing a supplemental reflection signature feature in the target detection process.

Horizontally polarized shear (SH) wave generation and detection is readily understood by considering the respective effects of an oscillating point shear force or an oscillating point shear stress at the ground surface. An oscillating point shear force will produce a time-varying horizontal shear displacement at the ground contact point which can be converted to time-varying particle velocity or particle acceleration motions in the ground by first and second time derivatives of the particle displacement. Similarly, an oscillating horizontal shear stress on a ground surface may be detected by a properly oriented motional velocity sensor, such as a geophone, or a properly oriented motional acceleration sensor, such as an accelerometer, both types of sensors having an axial direction of sensitivity. With either type of sensor, maximum response to radiated shear waves is achieved when the sensor axis is oriented parallel to the direction of shear force or displacement produced by the source. In contrast, when either type of sensor is oriented with its sensitive axis perpendicular to the direction of shear force or displacement, the sensor will exhibit a null response.

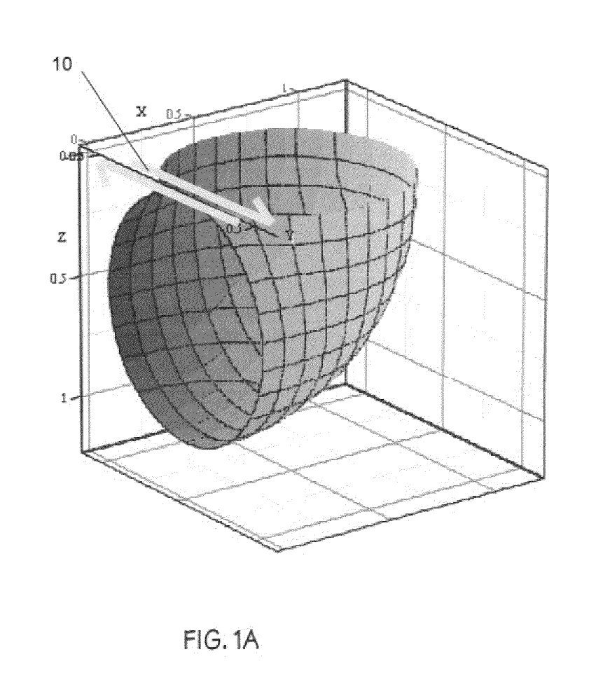

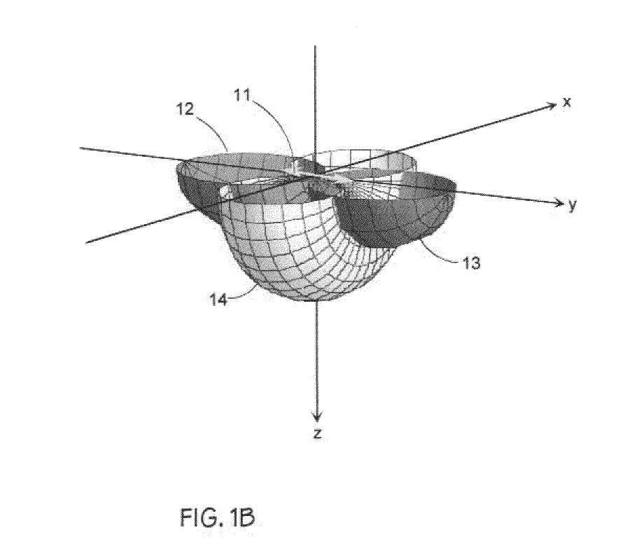

FIG. 1A shows the calculated radiation pattern of SH waves generated by a point shear force 10 applied to the surface of a semi-infinite half-space medium (X-Y plane). One half of the radiation pattern is cut away to show the semicircular cross-sectional shape of the torroidal pattern relative to the axial direction of the applied force 10. Because of the definition of the point source as an infinitesimal point, this semicircular torroidal pattern in the half-space is independent of the oscillating frequency of the applied force. In practice, this frequency independence will only be realized if the point contact force is applied over an area having dimensions that are smaller than the wavelength of the highest frequency of interest.

FIG. 1B shows the calculated radiation pattern of P-waves 12 and 13 generated by a point shear force 11 applied to the surface of a semi-infinite half-space medium. The indicated P-wave radiation occurs concurrently with the SH-wave radiation illustrated in FIG. 1A. Because of the dipole nature of the SH-wave source 11, the P waves radiated in lobes 12 and 13 are 180 degrees out of phase. The SH-wave radiation pattern 14 and P-wave radiation patterns 12 and 13 have null directions that are perpendicular to one another. Together, the SH- and P-wave radiation patterns shown in FIG. 1A and in FIG. 1B represent the total seismic radiation from the dipolar point shear force 11.

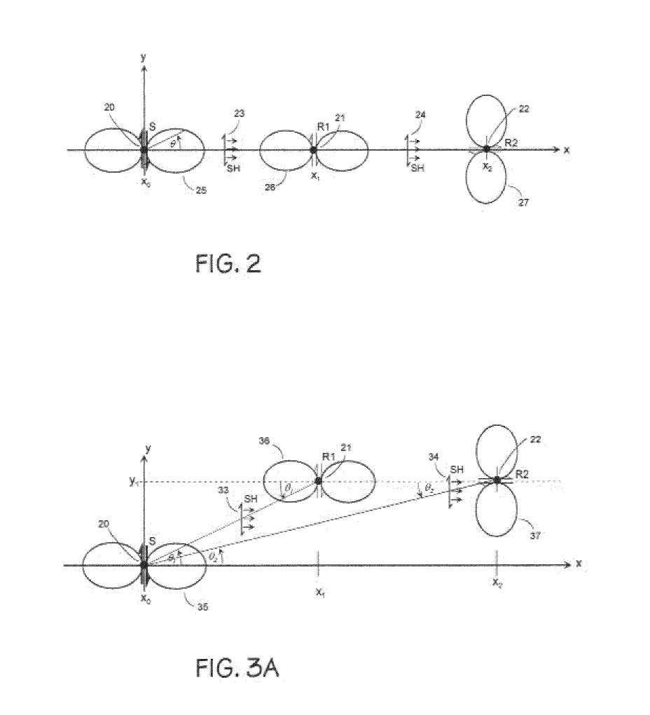

By reciprocity, a geophone or accelerometer sensor having its sensitive axis oriented parallel to the half-space surface will have a semicircular torroidal detection response pattern similar to that shown in FIG. 1A for SH waves arriving from different subsurface directions. Thus, by envisioning two such SH-wave patterns representing a source and a sensor spaced apart on, say, the x-axis of a Cartesian half-space layout and oriented with their axes parallel, the receiving pattern will exhibit maximum response to the source. Conversely, when the receiving pattern is rotated 90 degrees to the x-axis, the response to the source will be zero. FIG. 2 illustrates these maximum and null receiver responses in the plane of the half-space surface for direct SH-wave radiation 23 and 24 from a point SH-wave source 20 at position x₀. The generalized angular radiation pattern 25 of the source 20 has a “figure-eight” shape versus azimuth angle, θ, in the surface x-y plane. For the SH-wave source 20 and receiver 21 positions on the x-axis as shown in FIG. 2, the source 20 radiates maximum amplitude in the x-direction and the receiver 21 at position x₁ has its sensitive axis aligned parallel to the particle motions and displacements of the radiated SH waves 23 to produce maximum response to the SH waves 23, as governed by its response pattern 26. For the SH-wave source 20 and receiver 22 positions on the x-axis as shown in FIG. 2, the receiver 22 at position x₂ has its sensitive axis aligned perpendicular to the particle motions and displacements of radiated SH waves 24 to produce a null response, as governed by its response pattern 27.

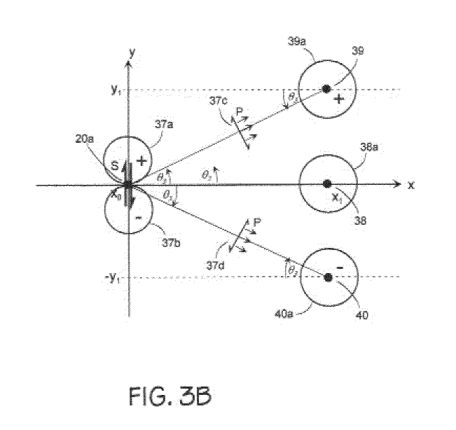

FIG. 3A shows an important aspect of the response of receiver 21 and receiver 22 when their centers are placed at positions laterally away from the x-axis with their sensitive-axis orientations unchanged. For both receivers 21 and 22 the respective SH waves 33 and 34 radiated by the source 20 are reduced in amplitude by respective factors of cos θ₁ and cos θ₂. Thus, the direct arrival response of the receiver 21 to SH wave 33 shown in FIG. 3A is reduced by the factor (cos θ₁)², as governed by the source radiation pattern 35 and the receiving pattern 36. However, in the case of receiver 22, since the sensitive axis of receiver 22 is still oriented perpendicular to the particle motions and displacements of SH wave 34, the response of the receiver 22 remains at a null. In a more generalized sense, the null response of the receiver 22 will occur for any position of the source 20 as long as the sensing axis of the receiver 22 is perpendicular to the particle motions and displacements of the SH waves radiated by the source 20.

For the case where the sensing array also contains vertical-axis sensors for detecting converted P-wave reflections arriving from the depth direction (z-axis), the direct cross-feed P-wave interference from the SH-wave source is relatively small for small values of angle θ₃ but is only at a null response when the P-wave sensing elements are on the line connecting the centers of source and sensor arrays. However, since the P-wave sensors are oriented to detect vertical displace motions from the depth direction (z-axis), they exhibit a null response to the cross-feed P-wave interference.

FIG. 3B illustrates this condition for an SH-wave source and P-wave sensor layout similar to that shown for SH waves in FIG. 2 and FIG. 3A. As shown in FIG. 3B, P-wave radiation from the SH-wave source 20a has two lobes 37a and 37b in which the P waves are 180 degrees out of phase as illustrated by + and − signs. The P-wave radiation from the source 20a also has a null on the SH-wave radiation axis (x-axis) with the P-wave radiation amplitude increasing to a maximum along the positive and negative shear displacement directions along the y-axis. The P-wave receiver 38 on the x-axis and the P-wave receiver 39 at a lateral position away from the x-axis have downward-directed responses 38a, 39a, and 40a for receiving P-wave reflections from the z-direction. Receiver 38 is in the P-wave null radiation direction of source 20a and also has its sensing axis vertically oriented so as to have a null response to P waves arriving directly from source 20a. Receivers 39 and 40, located laterally away from the x-axis, are excited, respectively, by positive and negative polarity P waves 37c and 37d from source 20a. However, because receivers 39 and 40 have their sensing axes vertically oriented, they exhibit an inherent null response to P-wave radiation 37c and 37d arriving directly from the source 20a. The P-wave radiation 37c and 37d have amplitudes that are governed by factors of sin(θ₃) and sin(−θ₃), respectively, thereby characterizing the source P-wave radiation null when θ₃=0 degrees and the respective P-wave radiation positive and negative maxima when θ₃=±90 degrees.

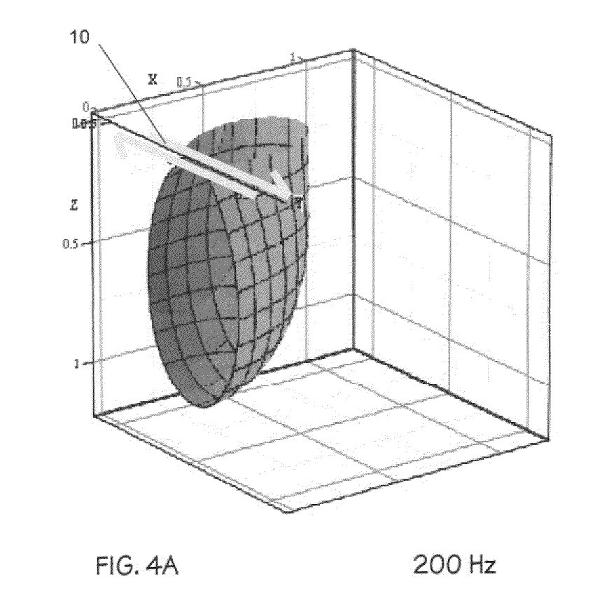

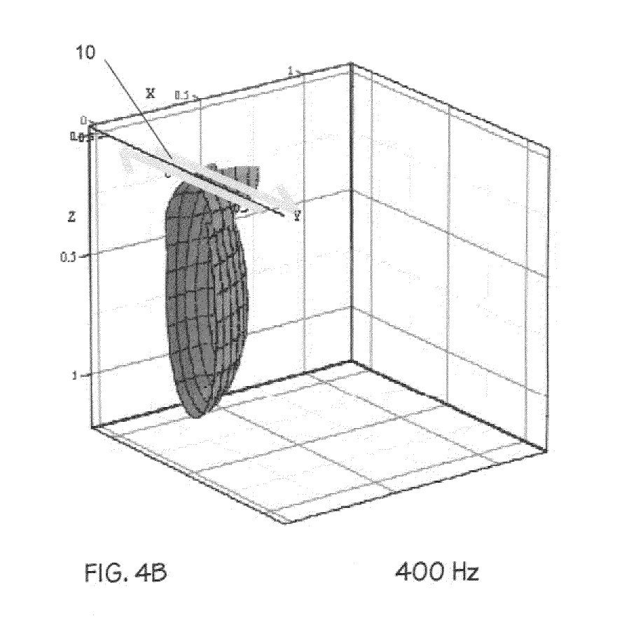

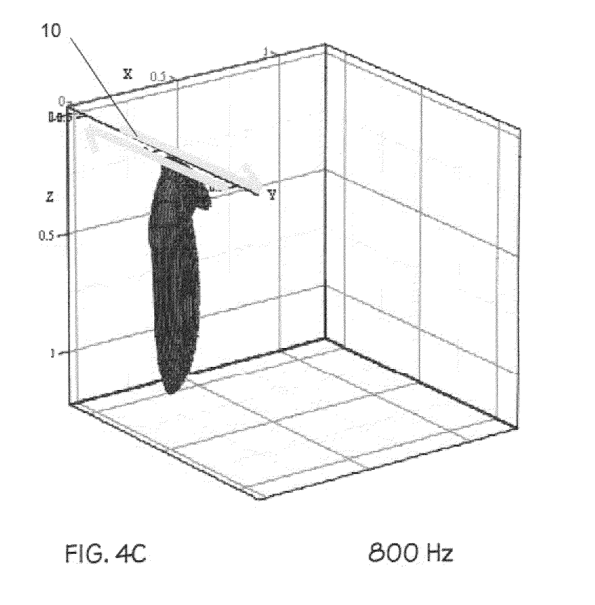

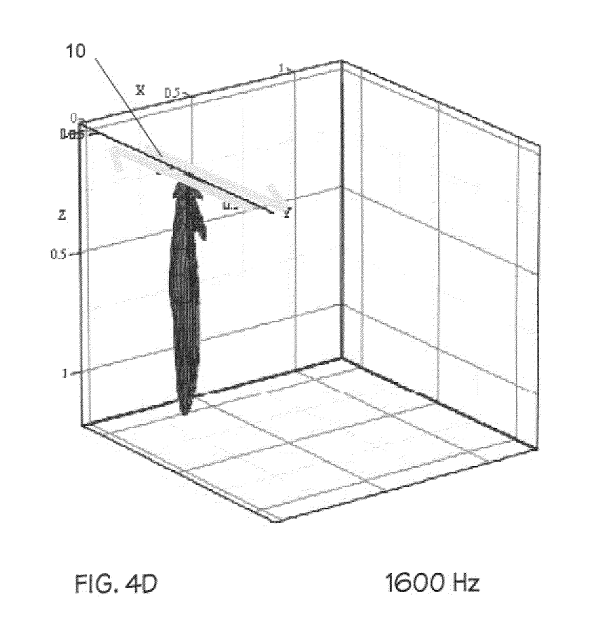

To detect elongate targets of interest, realization of a point source transducer may not be practical because of the need for a larger and more powerful source. In this case, the source transducer will have a finite contact area and radiating aperture on the ground surface. Such an aperture can be considered to be composed of a number of synchronized closely spaced smaller elements, typically point sources, representing the active contact of the source. To avoid spatial aliasing in the radiation pattern from such a multi-element point-source array, the element spacing must be less than one half wavelength at the highest operating frequency of interest. FIG. 4A through FIG. 4D show a series of calculated downward-directed radiation patterns for an array consisting of 36 SH-wave point sources in a 21-in.×40.5 in. rectangular element array. These patterns characterize SH-wave radiation over the three-octave frequency range 200-1,600 Hz in a ground medium having a shear wave propagation velocity of 750 ft/sec. These response patterns were calculated by superimposing the radiation from each element in the source array at a subsurface point located on an assumed reflecting target. By reciprocity, a sensor array having the same number and spacings of SH-wave point sensors as specified for the array in FIG. 4 will have detection response patterns equivalent to those shown in FIG. 4.

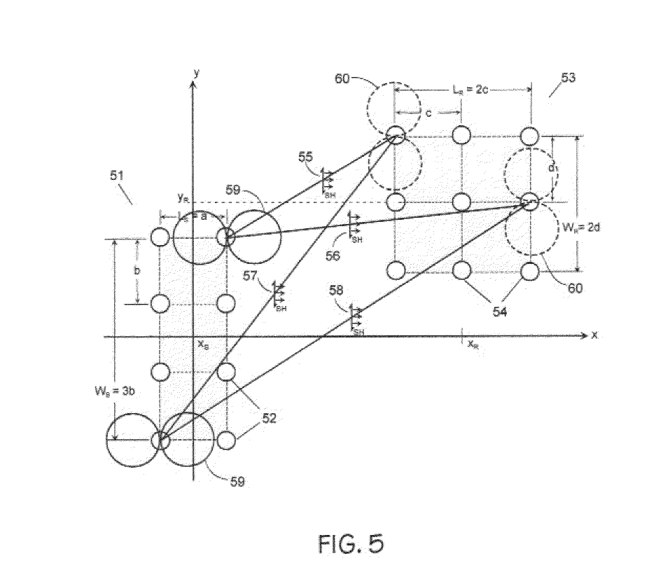

FIG. 5 illustrates a plan layout of a typical eight-element rectangular source array 51 and a nine-element sensor array 53 in the x-y plane on a half-space surface 50. Two examples of point-to-point direct SH-wave radiation from source array 51 to sensor array 53 are shown to illustrate how the source-sensor null response is preserved for these and other offset point-to-point signal transmissions. The null response previously illustrated in FIG. 3A is applicable to each of the direct-transmitted SH-wave signals such as 55, 56, 57, 58 between all combinations of the array elements and superimposed as shown, in part, in FIG. 5. The element spacings, a and b, between the elements 52 in the source array 51 give this array an aperture length of L_{S}=a and width of W_{S}=3b. Similarly, the element spacings, c and d, between the elements 54 of the sensor array 53 give that array an aperture of length of L_{R}=2c and width of W₈=2d. The aperture dimensions, L_{S}, W_{S} and L_{R}, W₈, of the source array 51 and the sensor array 53 shown in FIG. 5 may typically have rectangular or square array shapes and may be different from one another. The SH-wave sensors 54 of sensor array 53 have their sensing axes and associated receiving patterns 60 oriented perpendicular to the SH-wave radiation patterns 59 of source elements 52 of the source array 51.

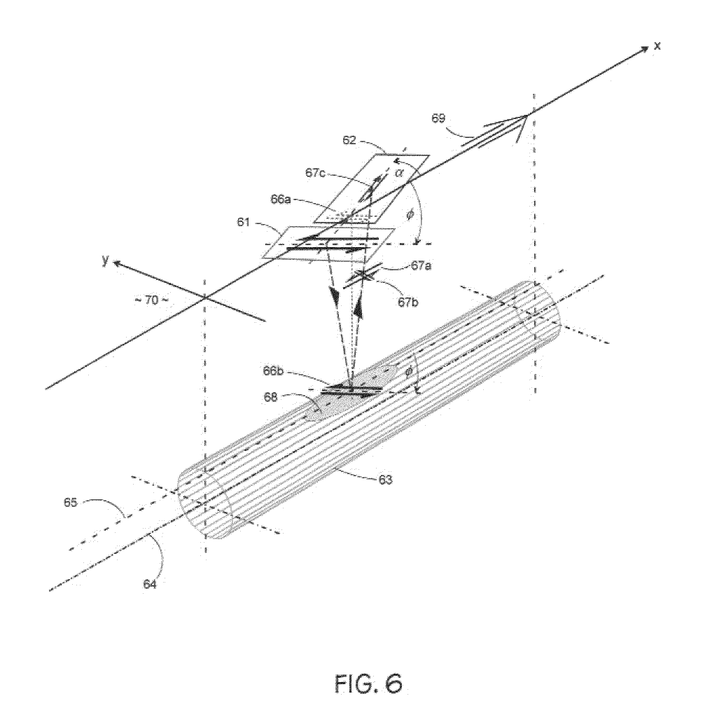

As mentioned in the Background above, the orthogonal orientation of the SH-wave source and sensor arrays serves to minimize or eliminate the direct cross coupling between the source and the sensor. Furthermore, any SH waves radiated downward from the source and reflected from horizontal layering in a transverse isotropic ground medium will be unchanged in their particle motion polarization and will arrive at the sensing array with orthogonal shear motion orientation and, hence, will not be detected by the sensor array. However, when a localized elongate subsurface reflector, such as a cylindrical pipe, is present, the SH-wave reflection characteristics of such a target will modify the incident SH-wave polarization upon reflection, to produce a component of SH-waves detectable at the sensing array. Such detectable reflections will depend on the angular orientation of the elongate target axis relative to the angular direction of the source and sensor pair on the ground surface. More specifically, the detectable component of the reflected SH waves along the sensitive axis of the sensor array will depend upon the obliquity of the SH wave angle of incidence on the elongate target. FIG. 6 is a 3D illustration showing this condition of oblique-polarized SH waves incident on a subsurface cylindrical reflector 63 for orthogonal source and sensor arrays 61 and 62 on the surface of a half-space ground medium 70.

As shown in FIG. 6, the source array 61 and the sensor array 62 are oriented orthogonally to eliminate direct SH wave arrivals 66a at the surface. The particle motion polarization of the down-going SH wave 66b from the source 61 is incident on the cylindrical target 63 at an oblique angle, φ, relative to the axis 64 of the cylinder 63. The incident angle, φ, is directly related to angle, α, which is the angle of the source-sensor array pair 61 and 62 in the x-y plane on the half-space surface 60 relative to the axis 64 and top surface line 65 of the subsurface cylindrical target 63. The oblique incident SH wave can be resolved into components that are parallel and transverse to the axis of the cylindrical target 63. The curvature of the cylinder causes the particle motions of the reflected parallel and transverse components of the incident SH waves 66a, namely, components 67a and 67b, to differ in amplitude from the of the components incident wave 66a depending upon angle, φ. The up-going reflected components 67a and 67b, when vectorially combined, will have a resultant polarization that differs from that of the incident wave 66a from source 61. Therefore, there will be a component 67c of the SH wave reflected from the cylinder 63 that is aligned with the sensitive axis of the sensor array 62. The magnitude of this component will be dependent on the angle, φ. FIG. 6 also shows, as one example of application, that the source-sensor array pair 61 and 62 is scanned along the ground surface (x-axis) 69 to track the subsurface layout direction of the cylindrical target 63. Alternatively, the same source-sensor array pair 61 and 62 may be scanned transversely over the target 63 to produce reflections having similar differences in SH-wave polarization. With knowledge of the two-way reflection time and the shear wave propagation velocity in the ground medium, the depth of the cylindrical target 63 may be determined.

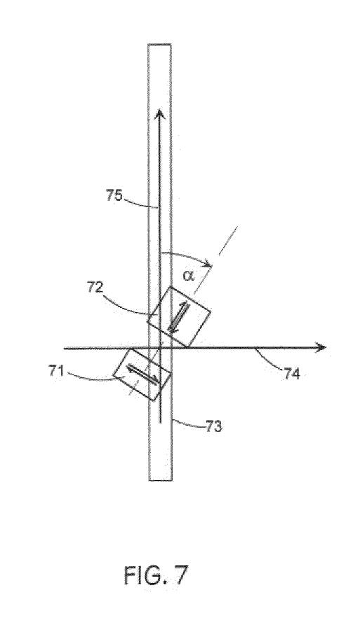

Also in reference to FIG. 6, the source and sensor arrays 61 and 62 are fixed in their spacing and orthogonal orientation to form a transducer system that may be moved as a unit over the ground surface 60 to scan the subsurface that may contain cylindrical targets. At such subsurface survey sites where the directional layout of any possible elongate targets is not known, a systematic rectangular ground scanning pattern can be executed over the survey area. Reflections may then be detected at positions where these scan lines cross over an elongate target and may be used to delineate the layout and linear extent of such detected targets. At survey sites where the general layout direction of elongate targets is known, such as in the case of underground pipes along the direction of a road or street, the survey scanning pattern can consist of lines either transverse or parallel to the road or street, or both. FIG. 7 illustrates an orthogonal SH-wave transducer-pair 71 and 72 oriented and scanned either perpendicular to the pipe 73 along path 74 or parallel to the pipe 73 along path 75 so that the down-going SH-waves are incident on the pipe at an oblique angle, φ=90°−α. For proper oblique SH wave incidence on the pipe during the scanning process, the orthogonal transducer-pair 71 and 72 must be maintained at the oblique angle, α, relative to the axial direction 75 when scanned along the alignment direction of the pipe and maintained at the complementary angle, 90°−φ, relative to the transverse direction 74 when scanned perpendicular to the pipe axis.

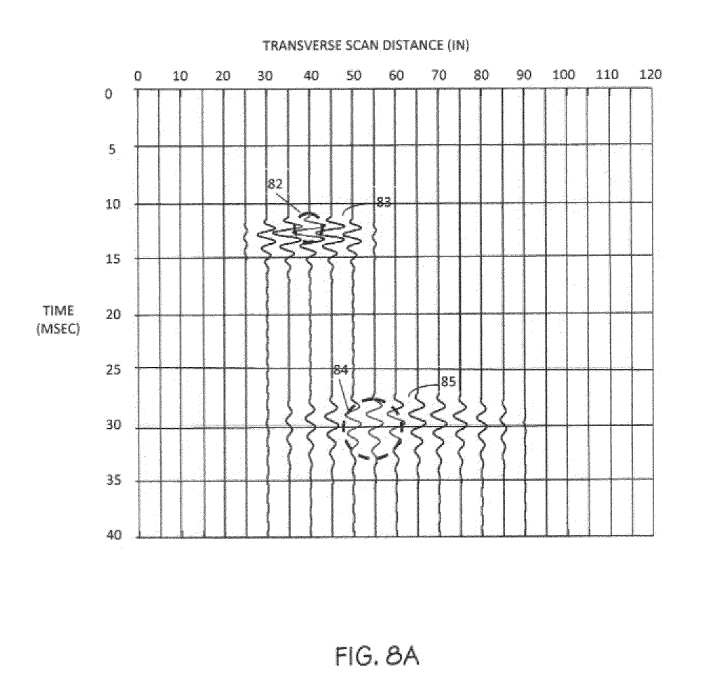

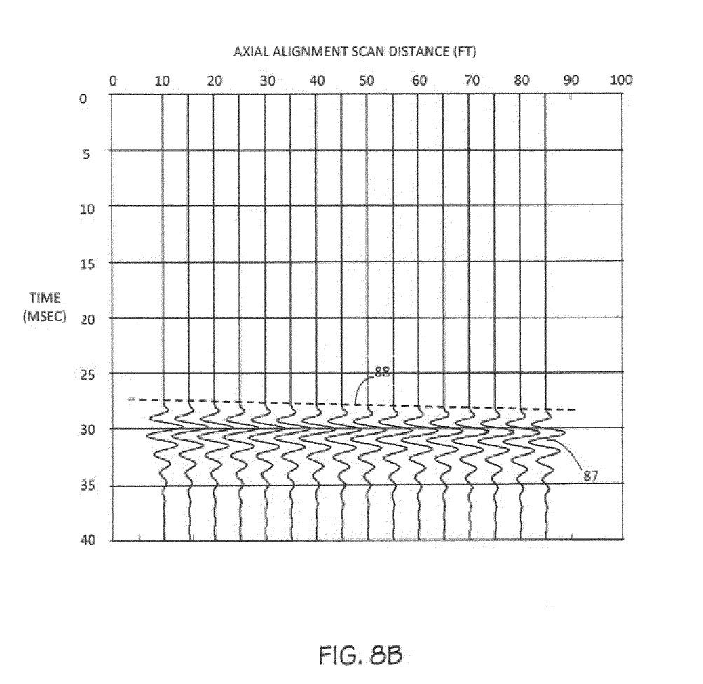

FIG. 8A shows a sketch of a typical seismic SH-wave reflection cross-section with its typical hyperbolic reflection patterns 83 and 85 from elongate targets when the source-sensor transducer-pair is obliquely oriented and scanned transverse to the pipe target axis. FIG. 8A shows two detection responses: one from a small diameter pipe 82 at shallow depth and one from a larger diameter pipe 84 at deeper depth. In this transverse scan, the positions and depths of the two targets are resolved by the reflections. The width of the hyperbolic pattern is limited in width by the finite source and sensor beam patterns and their limited overlap. FIG. 8B shows a sketch of a typical seismic SH-wave reflection cross-section 87 from the deeper elongate pipe target when the source-sensor transducer-pair is obliquely oriented and scanned directly above and parallel to the pipe axis. FIG. 8B shows the reflection response pattern 87 to have a small depth grade 88, indicative of a drainage pipe, as the transducer pair is scanned along the layout of the pipe. In this case, the depth of the pipe along its layout is indicated in detail. Although not illustrated in FIG. 8A or FIG. 8B, when the sensing array is equipped with vertical-axis P-wave sensors, the seismic cross-sections shown in FIG. 8A and FIG. 8B will include similar P-wave reflections arriving in advance of the SH-wave reflection times because of the faster propagation velocity of P waves in the ground medium.

Detection of elongate subsurface targets using SH waves in the manner described herein employs orthogonal source and sensor arrays to good advantage and also takes advantage of the asymmetrical reflection characteristics of elongate targets. Such target detection requires the source SH waves illuminating the target to be incident at an oblique angle relative to the elongate target axis so as to produce non-orthogonal responses at the sensor array. In this respect, there will be a particular oblique angle of incidence, or range of oblique angles, for which the sensor array will exhibit maximum detection response. This optimum detection condition is dependent upon:
a. SH-wave particle motion polarization of incident wave;
b. Shear wave propagation velocity in the host ground medium;
c. Pipe target diameter relative to the wavelength of the incident SH waves;
d. Contrast in materials comprising the pipe and the host ground medium;
e. SH-wave propagation losses incurred in traveling to and from the subsurface pipe target through the ground medium.
   The physical phenomena associated with plane SH waves scattered from cylindrical targets has been modeled analytically to show the dependence of steady-state SH-wave reflections on the factors listed above. The analytical results derived from this model indicate the distinct differences in the axial and transverse SH-wave reflection components described above. An extension of this analysis also shows that for a given spacing between the orthogonal source and sensor arrays there is an optimum range of SH-wave oblique angular incidence for which the SH-wave sensor array response is maximum. Parametric studies using the analytical model reveal the sensitivity of this receiving response to different ground seismic properties and different cylindrical target diameters and depths.

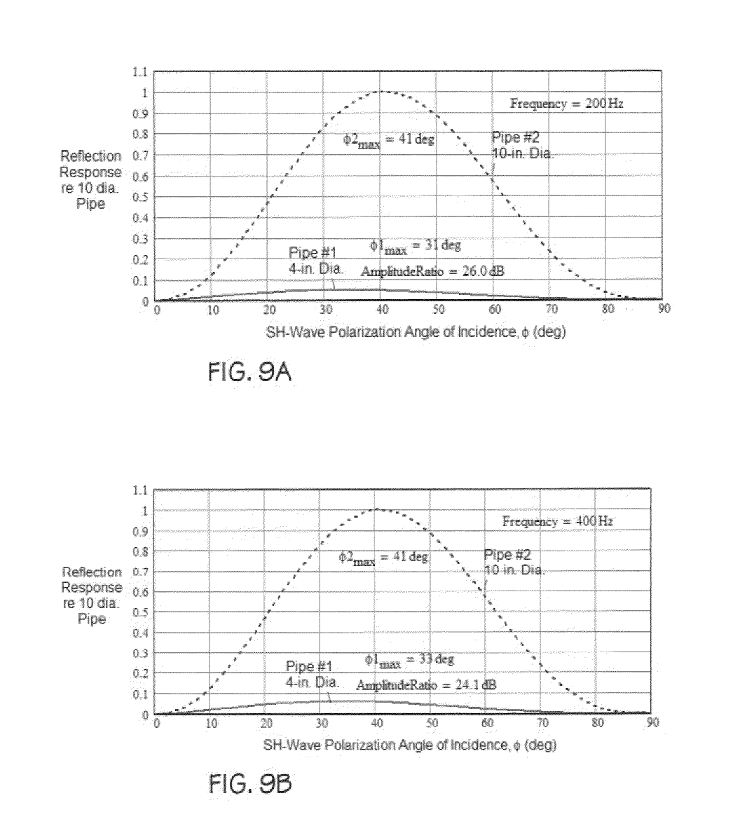

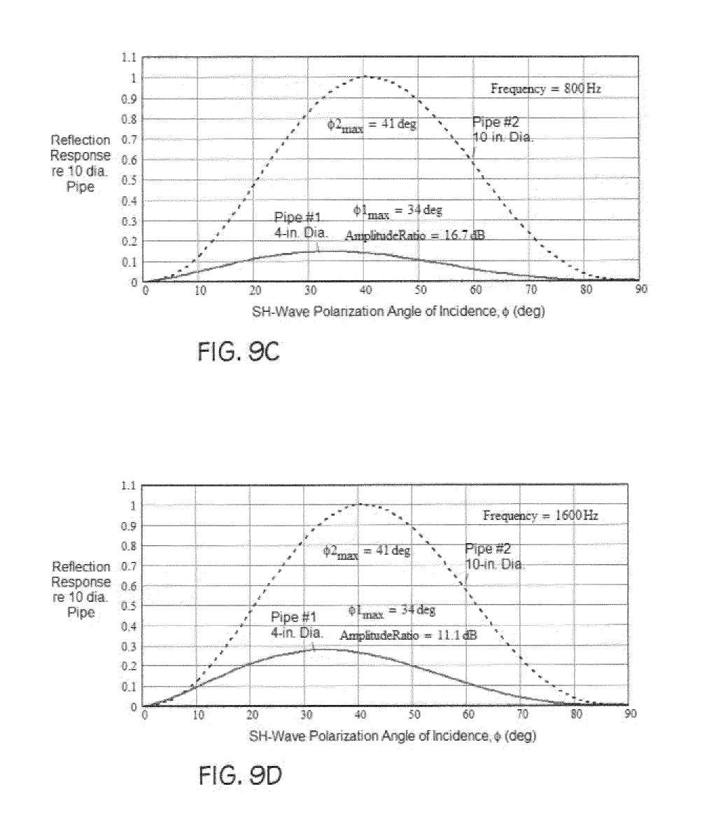

Two examples illustrating the optimum detection response derived using the analytical model are shown in FIG. 9. These responses are for two pipe sizes: 4-in. and 10-in. diameter, at a depth of 7 ft in a soil medium having shear wave velocity of 750 ft/sec. The series of responses shown in FIG. 9A through FIG. 9D at frequencies of 200, 400, 800, and 1600 Hz show the frequency dependence of the optimum oblique angle response for the two pipe sizes. As may be noted from this frequency dependence, the detection system must operate at frequencies at which the incident SH-wave wavelength in the soil medium is less than about 2-3 times the pipe diameter. The optimum oblique-incidence polarization for the 4-in. diameter pipe is 31-34 degrees for frequencies in the 400-1,600 Hz range. For the 10-in. diameter pipe, the optimum oblique-incidence polarization is 41 degrees for frequencies of 200-1,600 Hz. The pipe size and depth below surface have a direct effect on the magnitude of the detectable reflection signals but only a minor influence on the optimum angle of incidence. Because the range of oblique-incidence polarization is relatively broad for the two pipe diameters, field surveys performed at an intermediate oblique angle of about 36 degrees can be expected to allow pipe targets of 4-10 in. diameter to be detected. Alternately, when the pipe size and layout direction is known with reasonable certainty, the pipe detection and mapping survey can be optimized by experimentally determining the maximum response orientation of the orthogonal source-sensor transducer pair when the survey is initiated.

The analytical model used to derive the example oblique-incidence reflection results illustrated in FIG. 9 may also be implemented as a data processing tool specialized to improving and evaluating the detection of elongate targets. The essential features of this analytical model are adapted from the theoretical development presented by Pao, Y. H. and Mow, C. C. in Diffraction of Elastic Waves and Dynamic Stress Concentrations, Crane, Russak & Co., N.Y., 1971 and discussed by Aldrin, J. C., Blodgett, M. P., Lindgrin, E. A., Steffes, G. J., and Knopp, J. S. in “Scattering of Obliquely Incident Shear Waves from a Cylindrical Cavity,” J. Acoust. Soc., Vol. 129, No. 6, 2011 for steady-state scattering of plane elastic waves from circular cylinder targets. The data processing model replicates the concepts of the invention disclosed herein by defining a SH-wave source array and SH-wave sensor array spaced close together and oriented orthogonally on the surface of a homogeneous half-space elastic wave propagation medium. An approximately horizontal cylindrical inclusion representing an underground pipe is located below the surface of the half-space medium and approximately directly under the source-sensor transducer pair with its axis oriented obliquely with respect to the SH-wave particle motions and displacements produced by the source transducer. This model treats the incident SH wave as a plane wavefront which is valid for deep reflecting pipes but only approximate for shallow pipes. Spherical spreading and viscoelastic absorption in the half-space medium are included as amplitude factors to account for transmission and reflection propagation losses in the medium.

The objective of using such an analytical model to simulate the seismic SH-wave survey method disclosed herein is to predict the pipe detection signals from an assumed representation of the conditions at the survey site and compare the predicted results with the experimental results obtained in the survey. The comparison results are then used to systematically introduce changes in the assumed model conditions to improve the predicted results leading to a better comparison, and ultimately leading to a “best-fit” model. By superimposition of results, this modeling process can accommodate the possible presence of more than one pipe target in the half-space medium.

The principal parameters that are adjustable in the model include:
(1) Propagation velocity and viscoelastic attenuation of shear waves and compressional waves in the half-space medium;
(2) Diameter and material properties of the subsurface cylinder reflector;
(3) Source transducer excitation signal and operating frequency range;
(4) Positions of the SH-wave source and sensor transducers on the half-space surface relative to the survey coordinate origin, including their SH-wave polarization axes and intentional orthogonality;
(5) Position, depth, and spatial orientation of the subsurface cylinder reflector axis relative to the survey coordinate origin.
   The model adjustment parameters (1)-(4) define the physical characteristics of the half-space host medium, the subsurface pipe target, and the surface scan layout. These parameters are generally known or can be estimated for initial use in the model. If necessary, the propagation parameters in (1) may be measured by appropriate experimental methods for more accurate input information in the model. Although these parameters will be adjustable in the model, they will not change significantly in the process of matching the analytical model response to the recorded experimental response.

The model adjustment parameters (4) and (5) determine the geometrical positions and spatial relationships of the SH-wave system and the subsurface pipe target. The SH-wave system position parameters in (4) are established in advance by the field survey grid layout and, as the survey proceeds, the transducer positions will be documented during the field data recording process. As discussed above, the subsurface pipe target position parameters in (5) will often be known in a general sense although the actual underground layout and depth will not be known. Therefore, given the known or estimated values of the survey parameters in (1) through (4), the elongate pipe target positional parameters in (5) are the primary model adjustment factors.

The most direct application of this model-based data processing technique is one in which the simulation is applied to a noticeably present signal above any background noise in the recorded field data, relying upon the selective response of the system to elongate targets as the basis for the existence of the signal. In this case, the model is applied using the appropriately known and/or assumed input parameters associated with the identified potential pipe target reflections and the comparison process initiated. A less direct application will occur when the reflected signal is weak or masked by noise causing it to be unrecognizable in the recorded field data. In this case, signal-to-noise ratio enhancement techniques such as repetitive transient signal averaging, filtering, and boosting the high-frequency spectral content of the SH-wave source to offset anelastic attenuation, must be applied in order to establish the existence of possible coherent reflections from an elongate cylinder target. Complementary results can also be obtained from this model-based data processing technique by modeling and comparing multiple reflection records since, in most cases, the near-vertical seismic soundings recorded when scanning over a target will contain target reflections from slightly different source-sensor transducer pair positions. Although each such reflection response must be modeled and compared separately with its experimental data record, the spatial continuity of the pipe target can be established by the common position of the cylinder target axis and other related target features.

The model described above yields the frequency-domain plane-wave reflection coefficients of the cylinder target for certain assumed source, sensor, and target position parameters. These model-derived reflection coefficients are then used in a frequency-domain simulation of the reflection response, given the source excitation signal and the estimated propagation loss factors along the downgoing and upgoing paths in the half-space medium. These frequency-domain results are then transformed by Fast Fourier Transform analysis to the time domain to yield predicted time series reflected signals that may be compared with the experimentally recorded sensor output signals.

Numerous methods are applicable for comparing the predicted and experimental responses obtained using the SH-wave survey system described herein. The features of the recorded reflections are based, first, on the radiated SH waves being reflected from elongate cylinder targets and associated reflection geometry. Second, the time-series features of the recorded reflections are dependent on the time-series nature of the source excitation signal radiated into the medium by the SH-wave source, the spectral amplitude characteristics of the cylinder reflection coefficient, and the frequency dependence of the propagation losses along the illumination and reflection paths. The model-predicted responses can then be compared with the experimental response, both of which are time-series signals, by cross correlation analysis and other statistical signal parameter comparisons.

When applied to such seismic wave propagation applications, this model-prediction and data-comparison process is referred to as “matched-field processing” in which the synthesized pipe target reflection response is compared with the experimental response and adjusted by sequential comparisons and decision functions and changes in model parameter values to produce the closest match [Ref: Candy, J. V. (2006), Model-Based Signal Processing, John Wiley & Sons, Hoboken, N.J.]. Background experience and field practice provides the basis for setting the seismic propagation parameters of the host medium and the physical nature of the pipe targets of interest. Then, using the known SH-wave source and sensor system parameters and the ground survey layout and scanning pattern, the model analysis reduces to finding the most probable size, depth, and directional orientation of the elongate reflection target. In this regard, both the SH-wave and P-wave reflection features of the target can be combined to identify, track, and map the detected target with respect to the survey layout. A number of useful signal processing algorithms and tools are available for implementing this matched field modeling process for the specific seismic reflection application described herein [Ref: MATLAB® Signal Processing Toolbox, The MathWorks, Inc., Natick, Mass.].

The foregoing descriptions refer to concepts for detecting and locating elongate targets, such as underground utility pipes, using reflected horizontally polarized shear waves generated and received, respectively, by a source transducer and a sensing transducer located on the ground surface. The methods and techniques described and depicted in related illustrations herein disclose the essential concepts of the invention, including certain specific examples selected to allow accurate calculations and illustrations of typical seismic radiation patterns and to depict relevant transducer positioning and detection responses. These examples are used to convey the concepts and methods of the invention and, as such, are not intended to be construed in a limiting sense. On the contrary, various modifications of the described invention will become apparent to those skilled in the art upon reference to the descriptions of the invention. It is, therefore, contemplated that the appended claims will cover any and all such modifications, alternatives, and equivalents that fall within the true spirit and scope of the invention.

1. A seismic wave source and sensing system coupled to the surface of an elastic wave propagation medium comprising:
a seismic wave source transducer having a preferred axis of vibration oriented horizontally on the surface of said elastic wave propagation medium such that said source transducer is thereby capable of generating horizontal shear stresses in said medium which in turn cause dynamic particle motions and displacements in said medium that radiate as horizontally polarized shear waves, commonly referred to as SH waves, into said medium, said radiated SH waves propagating in a direction perpendicular to said shear stresses and displacements produced by said source transducer, said SH wave propagation being in the radial direction about the preferred axis of vibration of said source transducer including SH waves propagating in a downgoing direction into said elastic wave propagation medium;
a seismic wave sensing transducer having a preferred axis of vibration response oriented horizontally on the surface of said elastic wave propagation medium such that said sensing transducer is capable of detecting dynamic particle motions and displacements of SH waves provided that said seismic sensing transducer axis of vibration response is oriented parallel to or nearly parallel to the direction of said particle motions and displacements of said SH waves, said sensing transducer thereby being responsive to SH waves arriving from any radial direction around said sensing transducer preferred axis of vibration response including reflections of said downgoing SH waves incident upon an interface or object having contrasting physical properties with said elastic wave propagation medium;
an arrangement of said source and sensing transducers on the surface of said elastic wave propagation medium such that said preferred axis of vibration of said source transducer and said preferred axis of vibration response of said sensing transducer are orthogonally oriented with respect to one another so that SH waves radiated directly to said sensing transducer from said source transducer are not detected whereas said sensing transducer remains sensitive to SH waves that have dynamic particle motions and displacements polarized parallel or nearly parallel to said sensing transducer preferred axis of vibration response including reflections of said downgoing SH waves incident upon an interface or object having contrasting physical properties with said elastic wave propagation medium, said orthogonally oriented source and sensing transducers being located relatively close together as a fixed source-sensor transducer pair;
a recording system capable of acquiring and storing said reflected SH wave signals detected by said sensing transducer, said recorded signals representing reflections from contrasting physical properties within said elastic wave propagation medium.

2. The seismic source and sensing system of claim 1 wherein said source-sensor transducer pair operates to generate and radiate said SH waves in a generally downward direction into said elastic wave propagation medium such that said downgoing SH waves may encounter any physical contrasts that exist in said medium said contrasts being associated with possible layering of different geological materials, localized natural or man-made objects, or elongate objects such as underground pipes, conduits, cables, underground archaeological structures, paleolithic channels or other similar subsurface features which may reflect said downgoing SH waves, said localized objects and elongate objects in particular having SH wave scattering and reflection characteristics that may affect the polarization of the incident SH waves to produce reflected SH waves that are detectable by said sensing transducer.

3. The seismic source and sensing system of claim 1 wherein said sensing transducer is equipped with sensing elements having a preferred axis of vibration response oriented vertically on the surface of said elastic wave propagation medium such that said sensing transducer is capable of detecting dynamic particle motions and displacements of compressional waves, commonly referred to as P waves, said P waves being produced by an inherent wave-type conversion process when said downgoing SH waves are obliquely incident upon and reflect from said elongate target objects that have a cylindrical or other curved shape as in the form of an underground pipe or conduit, said converted P waves being upgoing reflections representing a supplemental detection and identifying feature differing from said SH wave reflections from such elongate targets.

4. The seismic source and sensing system of claim 1 wherein said source-sensor transducer pair is moved over the surface of said elastic wave propagation medium in such a manner that said generally downgoing SH waves may encounter subsurface objects and geological structures that exhibit contrasts in elastic properties between said objects and said medium, said contrasts giving rise to reflections and scattering of said incident SH waves detectable by said sensing transducer, said movements being along known or established traverse lines on the surface of said medium such that said reflected and scattered SH wave signals recorded by said source-sensor transducer system provide a means of locating and mapping said subsurface reflecting objects and their underground layouts and depths below the surface of said medium.

5. The seismic source and sensing system of claim 1 wherein said source-sensor transducer pair is intentionally oriented obliquely relative to the general layout direction of one or more suspected underground elongate objects such as for example underground utility pipes for the purpose of causing said downgoing SH waves radiated by said source transducer to be incident on said elongate objects at an oblique angle whereby reflections and scattering characteristics associated with said elongate objects modify the polarization of said oblique incident SH waves to produce reflections that are detectable by said sensing transducer said oblique angle of incidence having a particular range over which said detectable reflections may occur and within which there may be an optimum reflection response detectable by said sensing transducer.

6. The seismic source and sensing system of claim 1 wherein said sensing transducer is equipped with additional sensors having a vertically oriented vibration response capable of detecting said converted P waves as stated in claim 3, said additional P wave sensors operating simultaneously with said SH wave sensors to receive said upgoing P wave reflections produced by said downgoing SH waves incident on said elongate targets.

7. The seismic source and sensing system of claim 1 wherein said source transducer has a finite aperture by which said downgoing radiated SH waves are confined within a radiation beam that restricts the illumination of any said reflecting subsurface objects or geological contrasts to occur directly or nearly directly below the source transducer position on the surface of said elastic wave propagation medium and said sensing transducer has a finite aperture whereby said sensing transducer is responsive primarily to upgoing SH wave reflections confined within a receiving response beam said upgoing SH waves being reflections from any subsurface objects or geological contrasts located directly or nearly directly below said sensing transducer position on the surface of said medium, said source transducer and sensing transducer being sufficiently close together to allow their illuminating and receiving beams to overlap and thereby produce detectable responses from said underground localized or elongate objects such that said detectable responses are indicative of said reflecting objects or geological contrasts directly or nearly directly below said source-sensor transducer pair.

8. A seismic wave source and sensing system coupled to the surface of an elastic wave propagation medium such as a soil or rock material or paved road or street overlying a soil medium potentially containing subsurface elongate objects such as utility pipes, conduits, cables or other man-made structures comprising:
a seismic wave source transducer having a preferred axis of vibration oriented horizontally on the surface of said elastic wave propagation medium such that said source transducer is thereby capable of generating horizontal shear stresses in said medium which in turn cause dynamic particle motions and displacements in said medium that radiate as horizontally polarized shear waves, commonly referred to as SH waves, into said medium, said radiated SH waves propagating in a direction perpendicular to said shear stresses and displacements produced by said source transducer, said SH wave propagation being in the radial direction about the preferred axis of vibration of said source transducer including SH waves propagating in a downgoing direction into said elastic wave propagation medium;
a first seismic wave sensing transducer having a preferred axis of vibration response oriented horizontally on the surface of said elastic wave propagation medium such that said sensing transducer is capable of detecting dynamic particle motions and displacements of SH waves provided that said seismic sensor transducer axis of vibration response is oriented parallel to or nearly parallel to the direction of said particle motions and displacements of said SH waves, said sensing transducer thereby being responsive to SH waves arriving from any radial direction around said sensing transducer preferred axis of vibration response including reflections of said downgoing SH waves incident upon an interface or object having contrasting physical properties with said elastic wave propagation medium;
a second seismic wave sensing transducer having a preferred axis of vibration response oriented vertically on the surface of said elastic wave propagation medium such that said sensing transducer is capable of detecting dynamic particle potions and displacements of compressional waves, commonly referred to as P waves, said P waves being produced by an inherent wave-type conversion process when said downgoing SH waves are obliquely incident upon and reflect from said elongate target objects that have a cylindrical or other curved shape as in the form of an underground pipe or conduit, said converted P waves being upgoing reflections representing a supplemental detection and identifying feature differing from said SH wave reflections from such elongate targets, said second seismic wave sensing transducer being located congruently with said first seismic wave sensing transducer and operating simultaneously therewith to detect said converted P wave reflections produced by said downgoing SH waves obliquely incident on said elongate targets having a cylindrical shape or curvature;
an arrangement of said source and sensing transducers on the surface of said elastic wave propagation medium such that said preferred axis of vibration of said source transducer and said preferred axis of vibration response of said sensing transducer are orthogonally oriented with respect to one another so that SH waves radiated directly to said sensing transducer from said source transducer are not detected whereas said sensing transducer remains sensitive to SH waves that have dynamic particle motions and displacements polarized parallel or nearly parallel to said sensing transducer preferred axis of vibration response including reflections of said downgoing SH waves incident upon an interface or object having contrasting physical properties with said elastic wave propagation medium, said orthogonally oriented source and sensing transducers being located relatively close together as a fixed source-sensing transducer pair;
a recording system capable of acquiring and storing said reflected SH wave signals and said reflected P wave signals detected by said sensing transducers, said recorded signals representing reflections from contrasting physical properties including said elongate objects within said elastic wave propagation medium.

9. The seismic source and sensing system of claim 8 wherein said source-sensor transducer pair is moved over the surface of said elastic wave propagation medium within which is located one or more known or suspected said elongate objects for the purpose of detecting and mapping said elongate objects said system operating to generate oblique-incidence SH-wave radiation and detect SH waves and converted P waves reflected from said elongate objects said elongate objects having an inherent ability to modify the polarization of incident SH waves upon reflection when said illuminating SH waves are incident at an oblique angle, said movement of said source-sensor transducer pair being in the form of a rectilinear raster scan pattern that is advanced systematically over surface areas where said subsurface elongate objects may exist.

10. The seismic source and sensing system of claim 8 wherein said recorded SH-wave reflection signals are processed by analytically predicting the propagation and target reflection characteristics in said elastic wave propagation medium containing certain elongate target objects within said medium in such a way that said predicted reflection signals are compared with said experimentally recorded reflection signals, the results of said comparison process being used as a means of adjusting the analytical model parameters to better represent the SH-wave propagation conditions and reflecting target conditions in said medium, said analytical output results thereafter being used to depict and display the detected target layout and depth, potentially augmented with information on estimated diameter and material composition of said detected elongate targets when said targets have a cylindrical or other curved shape corresponding to underground pipes or other similar elongate objects.
